(19) United States
(12) Patent Application Publication
(10) Pub. No.: US 2011/0308618 A1
(43) Pub. Date: Dec. 22, 2011

(54) WATER RECOVERY SYSTEMS AND METHODS

(75) Inventor: Kenneth R. Lorenz, Ravensdale, WA (US)

(73) Assignee: UNIVERSAL WATER GROUP INC., Bellevue, WA (US)

(21) Appl. No.: 12/818,114

(22) Filed: Jun. 17, 2010

(51) Int. Cl. F15D 1/00; E03B 11/10

(52) U.S. Cl. 137/1; 137/572

(57) ABSTRACT

Water collection, treatment, and/or reutilization systems and methods are provided. Generally described, a water recovery system may include one or more condensate collectors, each associated with a condensate generator, and a collection tank. The condensate collectors collect condensate generated from the condensate generators and direct the collected condensate to the collection tank via appropriate piping, conduits, etc. The collection tank can thereafter distribute the waste water to a desired end use, such as for use in landscape irrigation, cooling towers, decorative fountains, gray water plumbing (i.e., toilet flushing), etc. The water recovery system may further include an automation, monitor, and control system for automating, monitoring, and/or controlling, for example, the flow of collected waste water, the treatment and/or filtration of the collected waste water, the end use of the collected waste water, etc.

### BACKGROUND

Water is an increasingly visible and expensive resource. Water is used to operate or cool many of the areas or devices within buildings and facilities. For instance, the water used to cool boilers, chillers, cooling towers, and other HVAC equipment of a large building (such as a warehouse, department store, shopping mall, manufacturing facility, hotel, school, convention center, etc.) typically consists of about 60% of the building's water use. With urban populations expanding, the demands on our planet's water system are increasing. Reducing water use can lower operational costs for a building and benefit the environment.

Moreover, in many situations, potable water or water of a high quality is used for all building devices and applications. For instance, high quality water is often used in cooling heat-generating devices (such as boilers, chillers, cooling towers, and other HVAC equipment), gray water plumbing, decorative fountains, landscape irrigation, or for maintaining certain equipment, such as cooling towers. In many of these applications, water of a lower quality or different quality may instead be used.

Thus, it can be appreciated from the foregoing that a system for water collection, treatment, and/or reutilization for certain end uses is desired. Furthermore, it is desirable that the system be easily integrated into a current or new building water system.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with aspects of the present disclosure, a water recovery system is provided. The water recovery system comprises one or more condensate collectors each associated with at least one condensate generator for collecting condensate therefrom, a cooling tower connected in liquid communication with the one or more condensate collectors, wherein the cooling tower discharges blow down water, a cooling tower collector for collecting the blow down water from the cooling tower, and a liquid storage tank connected in liquid communication with the cooling tower collector for holding at least the blow down water collected from the condensate generator, wherein the liquid storage tank includes an outlet for supplying the collected blow down water to a recycled use.

In accordance with another embodiment of the present disclosure, a method of reusing waste water is provided, comprises collecting condensate from one or more condensate generators, storing the collected condensate in a liquid storage tank as waste water, and supplying the waste water to at least one recycled use.

In accordance with another embodiment of the present disclosure, a water recovery system is provided. The system comprises a plurality of condensate collectors each associated with at least one condensate generator for collecting condensate therefrom, a liquid storage tank connected in liquid communication with the plurality of condensate collectors for holding at least the condensate collected from the condensate generators, wherein the liquid storage tank includes an outlet for supplying at least the collected condensate to a recycled use, and one or more conduits connecting the plurality of condensate collectors in liquid communication with the liquid storage tank.

In accordance with another embodiment of the present disclosure, a water recovery system is provided. The system comprises a plurality of condensate collectors each associated with at least one condensate generator for collecting condensate therefrom, at least one source of water, and a liquid storage tank connected in liquid communication with the plurality of condensate collectors and the at least one source of water for holding the condensate collected from the condensate generator and the water from the at least one source of water as waste water; wherein the liquid storage tank includes an outlet for supplying the waste water to a recycled use.

In accordance with another embodiment of the present disclosure, a water recovery system is provided. The system comprises a plurality of condensate generators, a plurality of condensate collectors associated with the condensate generators for collecting condensate therefrom, one or more conduits connected in fluid communication with the plurality of condensate generators, and a liquid storage tank connected in liquid communication with the one or more conduits for holding the condensate collected from the condensate generators, wherein the liquid storage tank includes an outlet for supplying the collected condensate to a recycled use.

In accordance with another embodiment of the present disclosure, a water recovery system is provided. The system comprises one or more condensate collectors each associated with at least one condensate generator for collecting condensate therefrom, and a liquid storage tank for holding at least the condensate collected from the condensate generator.

In accordance with another embodiment of the present disclosure, a storage tank for a water recovery system is provided. The storage tank comprises a tank body defining at least one cavity for holding waste water; an inlet for receiving the waste water, an outlet for supplying the waste water to a device external the tank, and one of more floats disposed within the cavity, the floats associated with signal generating devices for generating signals indicative of tank volume.

### DESCRIPTION OF THE DRAWINGS

The foregoing aspects and many of the attendant advantages of the disclosed subject matter will become more readily appreciated by reference to the following detailed description, when taken in conjunction with the accompanying drawings, wherein:

FIG. 1 is a schematic diagram of a first exemplary embodiment of a recovery system formed in accordance with aspects of the present disclosure;

FIG. 2 is a schematic diagram of a second exemplary embodiment of a recovery system formed in accordance with aspects of the present disclosure;

FIG. 3 is a schematic diagram of a third exemplary embodiment of a recovery system formed in accordance with aspects of the present disclosure;

FIG. 4 is a schematic diagram of an alternate embodiment of a portion of one of the recovery systems shown in FIGS. 1-3;

FIG. 5 is a side, partial cross-sectional view of a first exemplary embodiment of a tank system for use with the recovery systems shown in FIGS. 1-3;

FIG. 6 is a side, partial cross-sectional view of a second exemplary embodiment of a tank system for use with the recovery systems shown in FIGS. 1-3;

FIG. 7 is a partial side view of an intake pipe for use with the tank systems shown in FIGS. 5 and 6;

FIG. 8 is a schematic diagram of one exemplary embodiment of a control system formed in accordance with aspects of the present disclosure; and

FIG. 9 is a flow diagram of one exemplary embodiment of a routine implemented by a float switch program module in accordance with aspects of the present disclosure.

### DETAILED DESCRIPTION

Embodiments of the present disclosure will now be described with reference to the drawings where like numerals correspond to like elements. Embodiments of the present disclosure are generally directed to water collection, treatment, and/or reutilization systems suitable for in use with any building, facility, structure, etc., that generates non-sewage waste water that can be optionally treated and/or filtered and reused for the same or different end use. Embodiments of the present disclosure are further directed to systems and methods for automating, controlling, and monitoring one or more components of the water collection, treatment, and/or reutilization system (e.g., the flow of collected waste water, the treatment and/or filtration of the collected waste water, the end use of the collected waste water, etc.). Although exemplary embodiments of the present disclosure will be described hereinafter with reference to commercial building facilities, it will be appreciated that aspects of the present disclosure have wide application, and therefore, may be suitable for use with, for instance, ships, airplanes, residential buildings, manufacturing facilities, etc. Accordingly, the following descriptions and illustrations herein should be considered illustrative in nature, and thus, not limiting the scope of the present disclosure, as claimed.

Prior to discussing the details of various aspects of the present disclosure, it should be understood that the systems described herein employ mechanical and/or electrical components that perform one or more functions. It should be appreciated that each component may include one or more subcomponents that carries out some or all of the required functions. In that regard, each subcomponent of the system that may be separately used to individually carry out the functions of the system. Thus, the descriptions provided herein of components and their associated functions should not be construed as limiting the scope of the claimed subject matter.

It should also be understood that several sections of the following description are presented largely in terms of logic and operations that may be performed by conventional electronic components. These electronic components, which may be grouped in a single location or distributed over a wide area, may generally include processors, memory, storage devices, display devices, input devices (e.g., sensors, data entry devices, etc.), etc. It will be appreciated by one skilled in the art that the logic described herein may be implemented in a variety of configurations, including software, hardware, or combinations thereof. The hardware may include but is not limited to, analog circuitry, digital circuitry, processing units, application specific integrated circuits (ASICs), and the like. In circumstances where the components are distributed, the components are accessible to each other via communication links.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

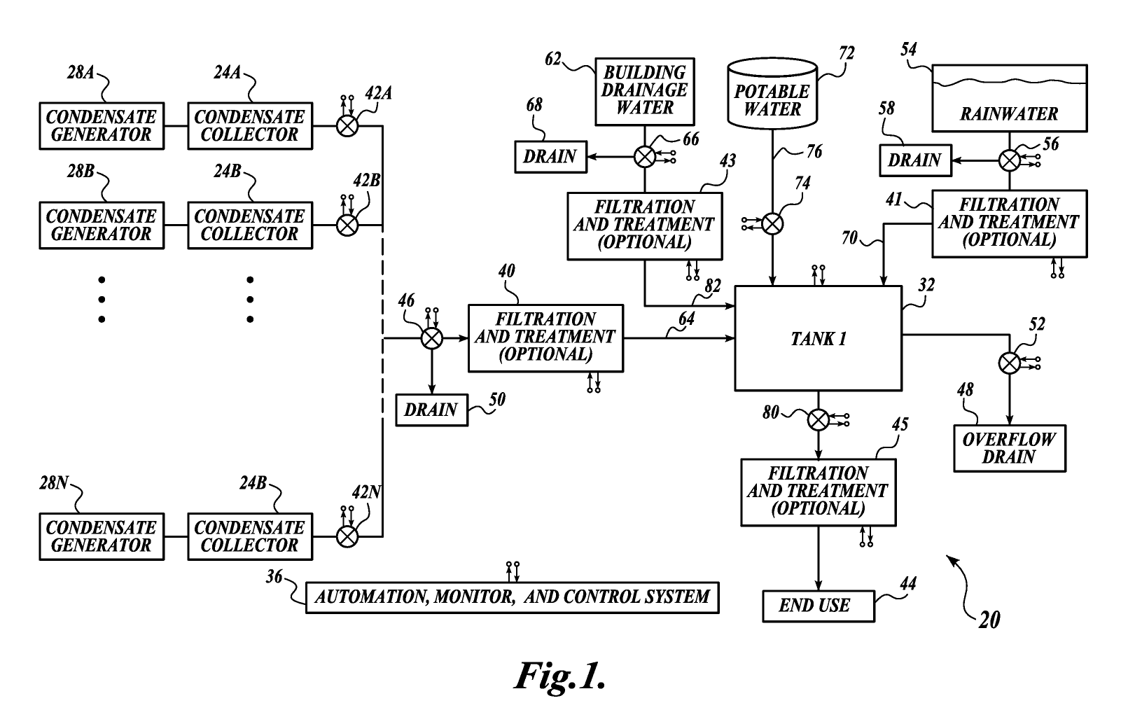

Turning now to FIG. 1, there is shown one exemplary embodiment of a water collection, treatment, and/or reutilization system, (a “water recovery system”), generally designated 20, formed in accordance with aspects of the present disclosure. Generally described, the water recovery system 20 may include one or more condensate collectors 24A-24N, each associated with a condensate generator 28A-28N, and a collection tank 32. The condensate collectors 24A-24N (hereinafter collectively referred to as “condensate collectors 24”) collect condensate generated from the condensate generators 28A-28N (hereinafter collectively referred to as “condensate generators 28”) and direct the collected condensate to the collection tank 32, via appropriate piping, conduits, etc. The collection tank 32 can thereafter distribute the waste water to a desired end use, such as for use in landscape irrigation, cooling towers, decorative fountains, gray water plumbing (i.e., toilet flushing), etc. Optional filtration and/or treatment components or systems 40 may be provided to filter and/or treat (e.g., purify, etc.) the collected waste water prior to being distributed for its end use. The water recovery system 20 may further include an automation, monitor, and control system 36 (hereinafter referred to as the “control system 36”) for automating, monitoring, and/or controlling, for example, the flow of collected waste water, the treatment and/or filtration of the collected waste water, the end use of the collected waste water, etc.

Referring still to FIG. 1, the components of the water recovery system 20 will now be described in more detail. The water recovery system 20 includes one or more condensate collectors 24 that collect condensate from an associated condensate generator 28, or devices that produce condensate when in use. For instance, heating, ventilation, and air-conditioning (HVAC) units (including HVAC packaged rooftop units (“RTUs”)), refrigeration units, and other similar units rely on evaporator coils through which refrigerant fluid changes from liquid to vapor, cooling the coils in the process. As the air blowing past the coils cools, moisture from the air condenses onto the coils to produce “condensate.” For instance, warehouses or other commercial buildings often include one or more RTUs that assist in cooling the building or portions of the building. It should be appreciated that the water recovery system 20 may be used with one or more condensate generators of any suitable type, now known or later developed.

In use, the condensate generators 28 drain the condensate into an associated condensate collector 24. The condensate collectors 24 may be any suitable design to collect condensate from at least one condensate generator 28. For instance, a tray, pan, or funnel may be disposed beneath the coils to collect the condensate as it drips from the coils. Alternatively, the condensate collector 24 may be a pipe fitting or the like that is coupled to the drain outlet of the RTU, refrigeration unit, HVAC unit, etc. The condensate collectors 24 are in fluid communication with suitable conduits or piping structure 64, such as copper pipe, PVC pipe, or any other suitable pipe, to direct the flow of the condensate away from the condensate collectors 24 and toward the collection tank 32.

Any suitable conduit or piping arrangement (optionally with back-flow valves) may be used to direct the flow of the condensate away from the condensate collectors 24 and toward the collection tank 32. For instance, individual pipes of the piping structure 64 may be connected to (i.e., in fluid communication with) each condensate collector 24, and the individual pipes may be connected directly to the collection tank 32 or may instead be in fluid communication with a common manifold or pipe that is connected to the collection tank 32. In the alternative, one pipe may be connected to two or more condensate collectors 24 that is coupled to either the collection tank 32 or a manifold that is connected to the collection tank 32. It should be appreciated that not all condensate collectors 24 need be coupled directly or indirectly to the collection tank 32. Rather, the condensate collectors 24 may instead feed into other portions of the water recovery system 20.

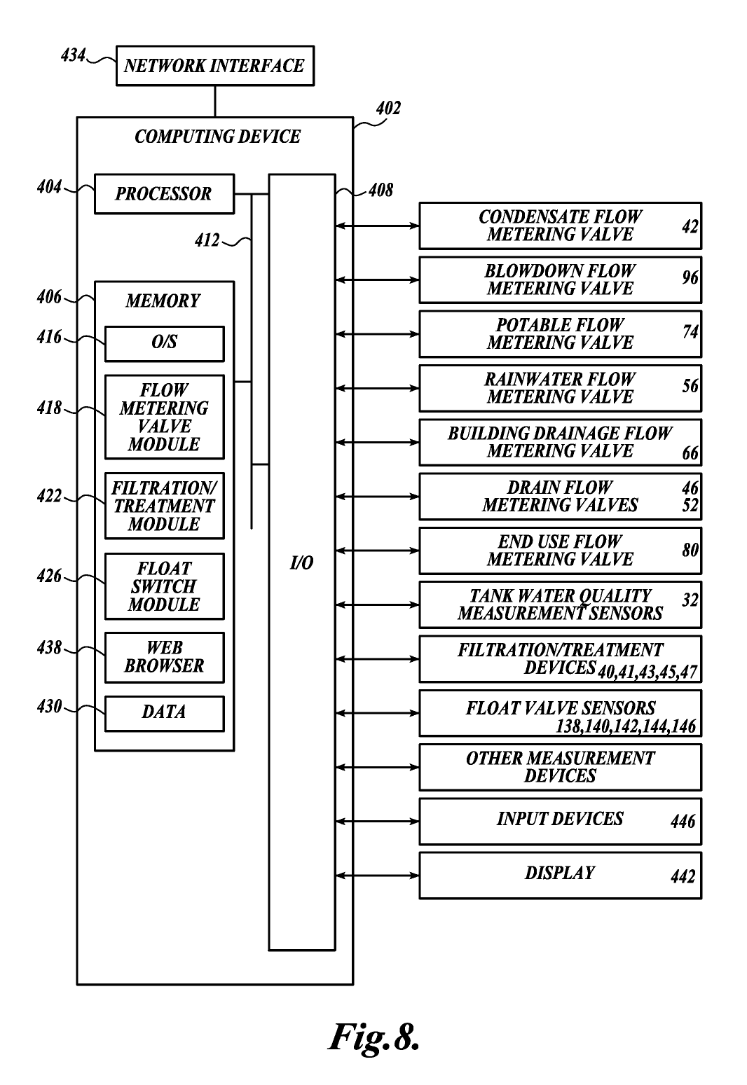

In one embodiment, a condensate electronic metering flow valve 42 may be placed into fluid communication with each pipe that directs the flow of condensate from the condensate collectors 24. The condensate electronic metering flow valve 42 is configured to monitor the flow of condensate fluid traveling within the corresponding pipe and to open or close a valve to selectively allow fluid flow through the pipe. For instance, the MAGFLO electromagnetic flowmeters, available from Siemens Flow Instruments A/S of Nordborg, Denmark may be used. However, it should be appreciated that the metering and valve functions may instead be carried out by separate components, as discussed above. In addition, the condensate electronic metering flow valve 42 or other sensors may optionally be configured to take certain water quality measurements, such as the TDS, level of contamination, etc. The electronic metering flow valves 42 communicate with the control system 36 via appropriate communication protocols known in the art. In that regard, the fluid flow monitoring and the opening and closing of the condensate electronic metering flow valve 42 may be under the direction of a systems operator via the control system 36 or it may be an automatic response by the control system 36 upon the execution of one or more program modules (see FIG. 8).

The pipes that direct the flow of condensate from the condensate collectors 24 may optionally be placed into communication with a condensate drain electronic metering flow valve 46 that, in addition to monitoring the flow of condensate, can selectively direct the flow of condensate into a condensate drain 50. For instance, if waste water levels in the collection tank 32 exceed a predetermined amount, the condensate drain electronic metering flow valve 46 may open to direct flow of condensate into the condensate drain 50 rather than into the collection tank 32. Similar to the condensate electronic metering flow valve 42, the condensate drain electronic metering flow valve 46 can communicate with the control system 36 via appropriate communication protocols known in the art. In that regard, the fluid flow monitoring and the opening and closing of the condensate drain electronic metering flow valve 46 may be under the direction of a systems operator via the control system 36 or it may be an automatic response by the control system 36 upon the execution of one or more program modules (see FIG. 8).

It should be appreciated that the condensate electronic metering flow valves 42 and the condensate drain electronic metering flow valve 46 may instead be replaced by a single electronic metering valve when, for instance, two or more condensate collectors are in fluid communication with a common manifold or piping structure. Additionally, it will be appreciated that the valve and metering functions can be separated into discrete components (i.e., valves and flow meters).

The collection tank 32 may be any suitable tank or holding device that is designed and configured to receive and hold waste water collected from one or more sources (including condensate collected by the condensate collectors 24) and distribute or otherwise release the waste water to a predetermined end use 44. It should be appreciated that throughout the description, the term “tank” shall include a collection of one or more tanks, or a single tank having multiple partitions.

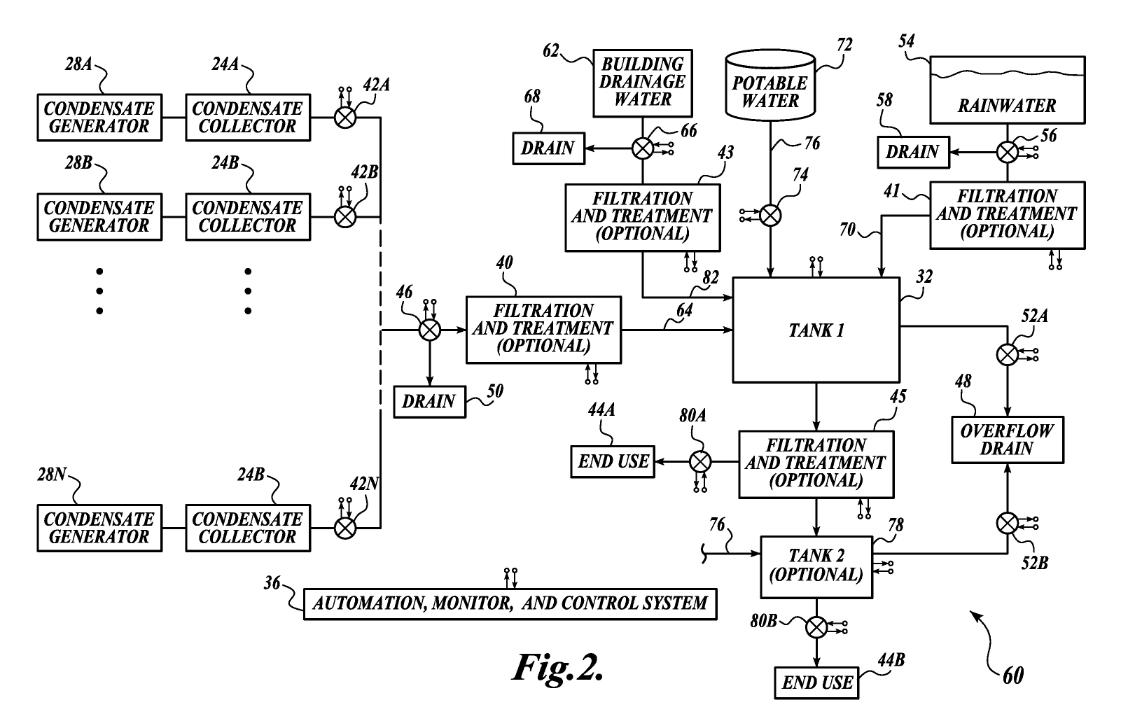

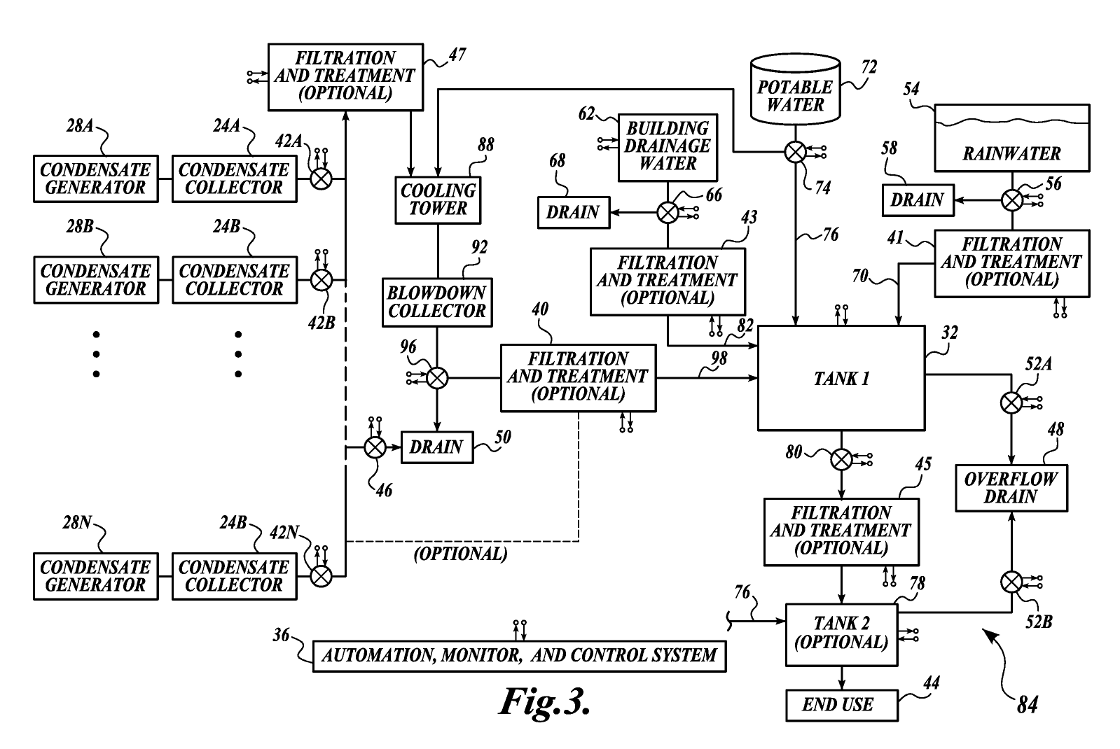

In one embodiment, the tank includes one or more pumps for pumping the waste water out of the collection tank 32. The pumps may be controlled by the control system 36 or by systems drawing water from the collection tank 32 for the designated end use 44. The collection tank 32 may further include an overflow drain 48 that is configured to discharge waste water to the building or facility drain or other suitable area when the waste water level in the collection tank 32 exceeds a predetermined amount. In that regard, the collection tank 32 may include a simple, mechanical one-way valve that allows fluid to discharge from the collection tank into the overflow drain 48. In another embodiment, a one-way overflow drain electronic metering valve 52 (or 52A if more than one tank is used, as will be described below), or an electronic flow meter separate from the one-way mechanical valve may be placed into fluid communication with the pipe for the overflow drain 48. (If a second collection tank 78 is used, as will be described below with reference to FIGS. 2 and 3, the second collection tank 78 may also be placed into communication with the overflow drain 48, optionally through a valve 52B). The overflow drain electronic metering valve 52 (or flow meter) is configured to monitor the flow of waste water draining from the collection tank 32. The overflow drain electronic metering valve 52 (or flow meter) can communicate with the control system 36 via appropriate communication protocols known in the art.

As will also be described below, the collection tank 32 may include sensors for determining the waste water level in the tank, the waste water quality in the tank, the flow of waste water into and out of the tank, and other desired sensors or measurement devices (such as temperature sensors, pressure sensors, etc.). The sensors and measurement devices also communicate with the control system 36 via appropriate communication protocols known in the art.

As noted above, the condensate may be optionally filtered or treated by passing through a purification, filtration and/or treatment system 40 (hereinafter “filtration and/or treatment system 40”) before reaching the end use 44. Any suitable filtration or treatment methods may be used depending on the quality of the condensate (for instance, the concentration of particulate matter or total dissolved solids (“TDS”)) and the end use of the condensate waste water. For instance, the condensate may be treated with chlorine or other disinfecting chemicals. Moreover, the condensate may pass through one or more filters or filter systems, such as ultraviolet (UV) filters, sediment filters, screen filters, cartridge filters, media filters, disk filters, centrifugal filters, etc. Furthermore, the condensate may be processed with reverse osmosis, nanofiltration, or integrated membrane systems. All of the above-described treatment and filtration devices and systems that may form all or part of the filtration and/or treatment system 40 are well known in the art and therefore will not be described herein in detail. It can be appreciated that any suitable arrangement of filters and treatment systems may be used depending on the quality of the condensate and the desired end use.

The filtration and/or treatment system 40 may be placed into fluid communication with the condensate piping such that the condensate is filtered and/or treated before reaching the collection tank 32. In the alternative, the filtration and/or treatment system 40 may be at least partially disposed within the collection tank 32 or may instead be placed into fluid communication with an outlet pipe leaving the collection tank 32. The filtration and/or treatment system 40 may communicate with the control system 36 via appropriate communication protocols known in the art. In that regard, the use of certain filtration and/or treatment devices available within the filtration and/or treatment system 40 may be employed upon initiation of a command sent from the control system 36 via a systems operator or may be employed automatically in response to the execution of one or more program modules (see FIG. 8) by the control system 36. In the alternative, or in addition thereto, certain portions of the filtration and/or treatment system 40 may be passive. More specifically, certain portions may fixed within the water recovery system 20 such that the condensate passing through the filtration and/or treatment system 40 occurs automatically.

Referring still to FIG. 1, optional components that may be provided with the water recovery system 20 will now be described in more detail. As discussed above, the collection tank 32 may receive waste water from one or more sources, including the condensate generator 28. In that regard, the collection tank 32 in one embodiment may additionally be in fluid communication with a source or collection of rainwater 54. For instance, the system 20 may collect rainwater in barrels, cisterns, and tanks such that the rainwater may be reused. The collection of rainwater 54 may be placed into fluid communication with the collection tank 32 with suitable conduits or piping structure 70, such as copper pipe, PVC pipe, or any other suitable pipe. The rainwater may pass through an optional filtration and/or treatment system 41 similarly constructed as the filtration and/or treatment system 40 described above.

Furthermore, a rainwater electronic metering flow valve 56 may be placed into fluid communication with the piping structure 70 that directs the flow of the rainwater from the collection of rainwater 54. The rainwater electronic metering flow valve 56 is configured to monitor the flow of rainwater traveling within the piping structure 70 and to open or close a valve to selectively allow rainwater flow through the piping structure 70. For instance, the rainwater electronic metering flow valve 56 may selectively allow rainwater to flow toward the collection tank 32, or if the waste water in the collection tank 32 has exceeded a predetermined amount, the rainwater may instead be directed to flow toward a drain 58. In addition, the rainwater electronic metering flow valve 56 or other sensors may optionally be configured to take certain water quality measurements, such as the TDS, level of contamination, etc. The rainwater electronic metering flow valve 56 communicates with the control system 36 via appropriate communication protocols known in the art. In that regard, the fluid flow monitoring and the opening and closing of the rainwater electronic metering flow valve 56 may be under the direction of a systems operator via the control system 36 or it may be an automatic response by the control system 36 upon the execution of one or more program modules (see FIG. 8).

The collection tank 32 in other embodiments may alternatively or additionally be in fluid communication with a source or collection of building drainage water 62, such as firewater, (i.e., water stored for sprinkler systems, etc.), reserved tap water, gray water (i.e., water used for plumbing), HVAC cooling water, or any other type of water that is collected within a building or facility that is periodically lost or “dumped” into the building drain(s). The collection of building drainage water 62 may be placed into fluid communication with the collection tank 32 with suitable conduits or piping 82, such as copper pipe, PVC pipe, or any other suitable pipe. The building drainage water may pass through an optional filtration and/or treatment system 43, similarly constructed as the filtration and/or treatment system 40 described above.

Furthermore, a building drainage water electronic metering flow valve 66 may be placed into fluid communication with the piping structure 82 that directs the flow of the building draining water from the collection of building drainage water 62. The building drainage water electronic metering flow valve 66 is configured to monitor the flow of building drainage water traveling within the piping structure 82 and to open or close a valve to selectively allow building drainage water flow through the piping structure 82. For instance, the building drainage water electronic metering flow valve 66 may selectively allow building drainage water to flow toward the collection tank 32, or if the waste water in the collection tank 32 has exceeded a predetermined amount, the building drainage water may instead be directed to flow toward a drain 68. In addition, the building drainage water electronic metering flow valve 66 or other sensors may optionally be configured to take certain water quality measurements, such as the TDS, level of contamination, etc.

The building drainage water electronic metering flow valve 66 communicates with the control system 36 via appropriate communication protocols known in the art. In that regard, the fluid flow monitoring and the opening and closing of the building drainage water electronic metering flow valve 66 may be under the direction of a systems operator via the control system 36 or it may be an automatic response by the control system 36 upon the execution of one or more program modules (see FIG. 8).

In other embodiments, the collection tank 32 may further be in fluid communication with a source of potable water 72, such as the building or facility's main water line. The source of potable water 72 may be placed into fluid communication with the collection tank 32 with suitable conduits or piping structure 76, such as copper pipe, PVC pipe, or any other suitable pipe. Furthermore, a potable water electronic metering flow valve 74 may be placed into fluid communication with the piping structure 76 that directs the flow of the potable water from the source of potable water 72.

The potable water electronic metering flow valve 74 is configured to monitor the flow of potable water traveling within the piping structure 76 and to open or close a valve to selectively allow potable water flow through the piping structure 76. For instance, the potable water electronic metering flow valve 74 may selectively allow potable water to flow toward the collection tank 32 if, for instance, the contamination level of the waste water in the collection tank 32 has exceeded a predetermined level and it needs to be “diluted” with potable water. Furthermore, the potable water electronic metering flow valve 74 may selectively allow potable water to flow toward the collection tank 32 if, for instance, level of the waste water in the collection tank 32 has fallen below a predetermined threshold level needed to supply water to the end use 44. In addition, the potable water electronic metering flow valve 74 or other sensors may optionally be configured to take certain water quality measurements, such as the mineral content of the potable water.

The potable water electronic metering flow valve 74 communicates with the control system 36 via appropriate communication protocols known in the art. In that regard, the fluid flow monitoring and the opening and closing of the potable water electronic metering flow valve 74 may be under the direction of a systems operator via the control system 36 or it may be an automatic response by the control system 36 upon the execution of one or more program modules (see FIG. 8).

As described above, the condensate, rainwater, building drainage water, and/or potable water, and combinations thereof, are in selective fluid communication with the collection tank 32. It should be appreciated that one or more additional collection tanks may also be provided that are in communication with some or all of the above-mentioned water sources.

For instance, in the depicted embodiment of the water recovery system 60 shown in FIG. 2, an optional second collection tank 78 is shown in fluid communication with the primary, or first collection tank 32 through a conduit or pipe (not labeled) as well as a source of potable water through piping 76. The second collection tank 78 may provide additional liquid storage if the holding storage of the first collection tank 32 is not sufficient. In this case, the “overflow” of waste water in the first collection tank 32 may flow into the second collection tank 78 rather than into the overflow drain 48, or in addition thereto. The second collection tank 78 may also be provided to supply waste water to a different end use. More specifically, the first collection tank 32 may supply waste water to a first end use 44A (through valve 80A), and the second collection tank 78 may supply waste water to a second end use 44B (through valve 80B).

An optional filtration and/or treatment system 45 similar to treatment system 40 (as described above) may be disposed between the first collection tank 32 and the end use 44 (see FIG. 1) or between the first and second collection tanks 32 and 78 (see FIG. 2). The filtration and/or treatment system 45 may further filter the waste water before it is directed to the end use 44, as shown in FIG. 1. The filtration and/or treatment system 45 may also filter the waste water before it is directed into the second collection tank 78 and thereafter to the end use 44B, as shown in FIG. 2. In the alternative, the first collection tank 32 may hold and distribute water to a first end use 44A that requires a first type of filtration and/or treatment (including no filtration or treatment), and the second tank 78 may hold and distribute water to a second end use 44B that requires a second type of filtration and/or treatment (see FIG. 2). For instance, the first collection tank 32 may distribute the waste water to a building gray water plumbing system (e.g., for flushing toilets), and the second collection tank 78 may distribute the waste water to an irrigation system.

A tank electronic metering flow valve 80 may be placed into fluid communication with the pipe(s) that directs the flow of waste water from the first collection tank 32 toward the end use 44, as shown in FIG. 1. If a second collection tank is used, as shown in FIG. 2, first and second tank electronic metering flow valves 80A and 80B may be used to selectively place the first and second collection tanks 32 and 78 into fluid communication with the first and second end uses 44A and 44B.

The tank electronic metering flow valves 80, 80A, and 80B are configured to monitor the flow of waste water traveling within the pipe and to open or close a valve to selectively allow waste water flow through the pipe. For instance, as noted generally above, it may be desired to have waste water flow from the first collection tank 32 into the second collection tank 78 if, for instance, the level of the waste water in the first collection tank 32 exceeds a predetermined level and additional waste water storage is needed. In this instance, the first tank electronic metering flow valve 80A may close to direct the flow of waste water into the second collection tank 78. Furthermore, the tank electronic metering flow valve 80A may close to allow waste water to flow into the second collection tank 78 if, for instance, the designated end use corresponding to the second tank 78 requires additional waste water. In addition, the tank electronic metering flow valves 80, 80A, and 80B or other sensors may optionally be configured to take certain water quality measurements, such as the TDS, level of contamination, etc.

The tank electronic metering flow valves 80, 80A, and 80B communicate with the control system 36 via appropriate communication protocols known in the art. In that regard, the fluid flow monitoring and the opening and closing of the tank electronic metering flow valves 80, 80A, and 80B may be under the direction of a systems operator via the control system 36 or it may be an automatic response by the control system 36 upon the execution of program modules (see FIG. 8).

Referring now to FIG. 3, a water recovery system 84 described in accordance with an alternate embodiment of the present disclosure is depicted. The water recovery system 84 is substantially similar to the water recovery system 20 described above except for the differences hereinafter described. In that regard, the water recovery system 84 is similar to the water recovery system 20 in that it includes one or more condensate collectors 24, each associated with a condensate generator 28, and a collection tank 32. As noted above, the condensate collectors 24 collect condensate generated from the condensate generators 28 and direct the collected condensate to the collection tank 32. However, in the water recovery system 84 depicted in FIG. 3, the condensate may optionally be directed for use in a heat removal device, such as a cooling tower 88. Moreover, in the water recovery system 84 depicted in FIG. 3, an optional second collection tank 78 is shown that may be used for overflow from the first collection tank 32, similar to that described above with reference to FIG. 2.

As is well known in the art, cooling towers are heat removal devices used to transfer process waste heat to the atmosphere. More specifically, cooling towers may use the evaporation of water to remove process heat and cool a working fluid. In a typical cooling tower unit, cool water is pumped from a cooling tower basin (i.e., the circulating water) and is routed through the heat-generating devices (such as coolers, condensers, boilers, etc.) in an industrial facility or building. The cool water absorbs heat from the hot process streams which need to be cooled or condensed, and the absorbed heat warms the circulating water. The warm water returns to the top of the cooling tower and trickles downward over the fill material inside the tower. As it trickles down, it contacts ambient air rising up through the tower either by natural draft or by forced draft using large fans in the tower. That contact causes a small amount of the water to be lost as windage and some of the water to evaporate.

The heat required to evaporate the water is derived from the water itself, which cools the water back to the original basin water temperature and the water is then ready to recirculate through the heat-generating devices. The evaporated water leaves its dissolved salts or other minerals or particles behind in the bulk of the water which has not been evaporated, thus raising the mineral concentration or TDS in the circulating cooling water. After the water has recirculated through the heat generating devices and the cooling tower, the particle concentration of the water may become too high, thereby possibly causing damage to the cooling tower components. To prevent particle concentration of the water from becoming too high, a portion of the basin water is typically drawn off or “blown down” for disposal (also referred to as “bleeding off” or “blowing out”) after a predetermined number of circulation cycles. Moreover, fresh water makeup is supplied to the tower basin to compensate for the loss of evaporated water, the windage loss water and the blow-down water.

In the water recovery system 84, some or all of the condensate collected from the condensate generators 28 can be directed to flow toward the cooling tower 88 for use as makeup water through a suitable piping arrangement. The condensate collected from condensate generators 28, such as HVAC units or RTUs, is typically the quality of distilled water (having a low TDS) and is therefore suitable for use as makeup water in the cooling tower 88. However, the condensate may optionally pass through a filtration and/or treatment system 47, similarly constructed to the filtration and/or treatment system 40 (as described above), if needed. Since condensate is more suitable for makeup water, for instance, in comparison to potable water that is normally used, the use of condensate can increase the number of circulation cycles and decrease the chance of erosion of cooling tower components. If makeup water is not needed by the cooling tower 88, the condensate may instead flow directly to the collection tank 32 (and optionally through a filtration and/or treatment system 40).

Cooling towers often include sensors or other devices that measure the mineral concentration, TDS, the pH balance, etc., of the circulating water. The cooling tower sensors and/or measurement devices may communicate with the control system 36 via appropriate communication protocols known in the art to transmit signals indicative of water quality thereto. In that regard, if the sensors detect a high level of mineral concentration in the circulating water, the control system 36 may open the condensate electronic flow metering valve(s) 42 (either automatically or through commands initiated by a systems operator) to allow condensate collected by the condensate collectors 24 to flow toward the cooling tower 88 for use as makeup water. As noted above, to prevent the mineral concentration of the cooling tower water from becoming too high, a portion of the basin water is typically drawn off or “blown down” for disposal. This blow-down water is typically emptied to the building or facility drain. In the water recovery system 84, however, a blow-down water collector may be placed into communication with the cooling tower 88 for collecting and directing the flow of the blow-down water toward the collection tank 32 for reuse. For instance, a conduit or pipe may simply be placed into fluid communication with the cooling tower basin to capture the blow-down water from the cooling tower 88 during the blow-down process. In the alternative, a separate tray, pan, or funnel may be disposed beneath the cooling tower 88 to capture the blow-down water.

The collected blow-down water may optionally pass through a filtration and/or treatment system 40 (as described above) before reaching the collection tank 32. In addition, a cooling tower electronic metering valve 96 may be placed into fluid communication with the piping structure 98 that directs the flow of blow-down water from the blow-down collector 92. The cooling tower electronic metering valve 96 is configured to monitor the flow of blow-down water traveling within the piping structure 98 and to open or close a valve to selectively allow fluid flow through the piping structure 98. In addition, the cooling tower electronic metering valve 96 or other sensors may optionally be configured to take certain water quality measurements, such as the level of mineral concentration. The cooling tower electronic metering valve 96 communicates with the control system 36 via appropriate communication protocols known in the art. In that regard, the fluid flow monitoring and the opening and closing of the cooling tower electronic metering valve 96 may be under the direction of a systems operator via the control system 36 or it may be an automatic response by the control system 36 upon the execution of program modules (see FIG. 8).

The above-described water recover systems 20, 60, and 84 may employ either gravity, pumps, and/or vacuum pumps to direct the flow of fluid. For instance, if one or more condensate generators 28 are located on the ground floor of a building (as opposed to the roof top), vacuum pumps may be used to direct the flow of the condensate collected by the condensate collectors 24 to the collection tank 32. In the alternative, the collection tank 32 may be located below ground level such that gravity may still be used to direct the flow of condensate fluid into the collection tank 32. The same may be used for any of the other sources of water, such as the collection of rainwater 54, the building drainage water 62, or the blow-down water from the cooling tower 88. Furthermore, it should be appreciated that the piping structures carrying the waste water may include appropriate back-flow valves.

Furthermore, although multiple drains are shown, it should be appreciated that one or more sources of waste water (condensate, rainwater, building drainage water, and/or blow-down water) may instead drain into a single drain. Furthermore, the waste water from one or more sources may instead pass through the same filtration and/or treatment system 40 rather than requiring separate systems for each source of waste water.

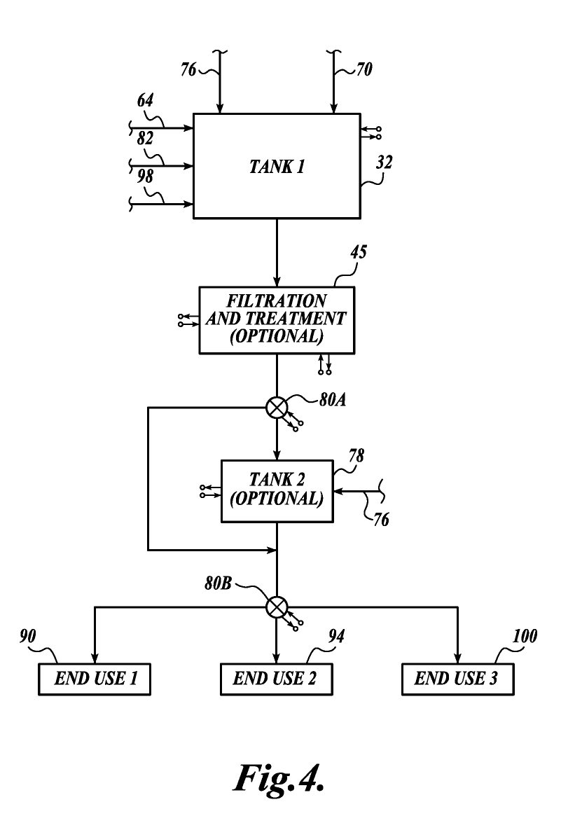

Referring to FIG. 4, an alternative arrangement of a portion of one of the water recovery systems 20, 60, or 84 is depicted. The first collection tank 32 is shown connected to the piping structures 64, 70, 76, 82, and 98 of sources of condensate, rainwater, potable water, building drainage water, and blow-down water, respectively. An optional second tank 78 is also shown, which may be connected to the piping structure 76 of a source of potable water. Further with reference to the description provided above, an optional filtration and/or treatment system 45 may be positioned between the first and second collection tanks 32 and 78 to further filter the waste water before it is released to its end use.

In the depicted embodiment in FIG. 4, however, the tank electronic metering flow valves 80A and 80B optionally places the first and/or second collection tank into fluid communication with first, second and/or third end uses 90, 94, or 100, respectively. In this case, the specific filtration and/or treatment methods employed may depend on the selected end use(s) 90, 94, or 100. For instance, if the first end use 90 is irrigation, the second end use 94 is decorative fountains, and the third end use 100 is makeup water for cooling towers, the waste water may be filtered or treated differently for each use, and different levels of potable water may be added to the first and/or second collection tank to appropriately dilute the waste water.

As briefly discussed above, the filtration and/or treatment system 45 is configured similar to the filtration and/or treatment system 40, which may communicate with the control system 36 via appropriate communication protocols known in the art. In this manner, the selection of the treatment and/or filtration may be selected by the control system 36 depending on the desired end use and its water quality requirements. The treatment and/or filtration of the waste water may be selected by a systems operator via the control system 36 or may be an automatic response by the control system 36 upon the execution of one or more program modules (see FIG. 8).

In addition or as an alternative thereto, the flow valves 80A and/or 80B may optionally place the first and/or second collection tank into fluid communication with first, second and/or third end uses 90, 94, or 100, respectively, at preselected times of the day, week, month, etc., depending on the needs of the building or facility in which the water recovery system 20, 60 or 84 is implemented. For instance, if the first end use 90 is irrigation, the control system 36 may automatically cause the flow valve 80A and/or 80B to place the first and/or second collection tank into fluid communication with the first end use 90 every morning at 6:00 am (e.g., for watering plants, grass, etc.). However, if the building facility land has received significant rainfall, the systems operator may, via the control system 36, disrupt this schedule, thereby allowing more waste water to be used for the second and third end uses 94 and 100. Similarly, the control system 36 may automatically or through commands initiated from a systems operator, cause the flow valve 80A and/or 80B to place the first and/or second collection tank into fluid communication with the second or third end uses 94 and 100 at certain preselected times during each day, week, etc.

In addition or as an alternative thereto, the flow valve 80A and/or 80B may optionally place the first and/or second collection tank into fluid communication with first, second and/or third end uses 90, 94, or 100, respectively, depending on the waste water level in the first and/or second collection tank. For instance, the first, second and/or third end uses 90, 94, or 100 may be given a designated priority for use of the waste water if the level of waste water in the first and/or second collection tank falls below a predetermined level. In such a case, potable water may be supplied to one or more of the other end uses.

It should be appreciated that any other operational condition may instead be used to determined which of the first, second and/or third end uses 90, 94, or 100 receives waste water from the first and/or second collection tanks at designated times.

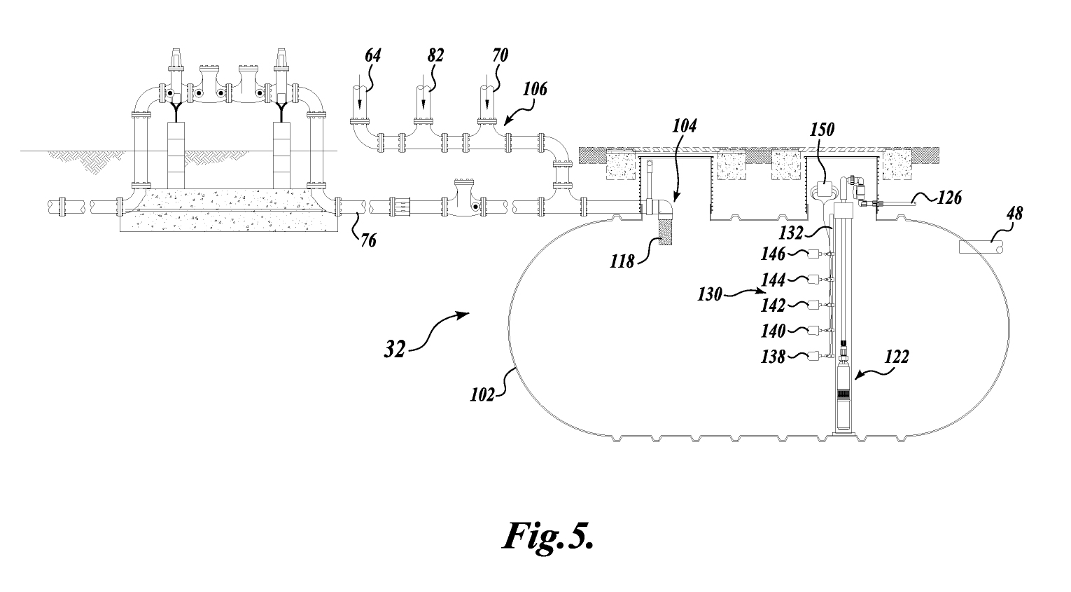

Turning now to FIG. 5, a representative embodiment of the collection tank 32 for use with the above-described water recover systems 20, 60, and 84 will be hereinafter described. As best shown in FIG. 5, the collection tank 32 includes a tank body 102 that may be formed from any suitable material using any suitable method. For instance, the tank body 102 shown in FIG. 5 is a fiberglass tank body, although a concrete tank body may instead be used. As shown in FIG. 5, the tank body 102 may be buried beneath the ground surface; however, it should be appreciated that the tank body 102 may instead be positioned above the ground, inside the building, etc.

The tank body 102 includes at least one opening (not shown) for receiving an inlet conduit or pipe 104. The inlet pipe 104 is in fluid communication with, and receives waste water from, piping structures connected to one or more waste water sources. In the embodiment depicted, the inlet pipe 104 is in fluid communication with an intake manifold 106 that collects the waste water from several sources and feeds or otherwise directs the flow of the waste water into the inlet pipe 104 and down into the tank body 102. For instance, the intake manifold 106 may be in communication with piping structures 70, 82, and 64, coming from the condensate collectors 24, the collection of rainwater 54, and the building drainage water, respectively. It should be appreciated that additional waste water sources (such as the blow-down water) may be in communication with the intake manifold 106 or may instead be introduced into the tank body 102 through a separate inlet pipe. The inlet pipe 104 may also be in fluid communication with the piping structure 76 of a source of potable water. As such, the potable water can be introduced into the tank body through the inlet pipe 104 as needed to dilute the waste water in the collection tank 32.

As noted above, one or more filtration and/or treatment systems 40 may be used to treat and/or filter the waste water before it is distributed to its end use. In the embodiment depicted in FIG. 5, a sediment filter 118 is placed on the end of the inlet pipe 104 such that waste water entering the tank body 102 passes through the sediment filter 118. It should be appreciated that the sediment filter may instead be placed into communication with the inlet pipe 104 outside the tank body 102. Moreover, other filters and/or treatment systems may also be used in addition or in the alternative to the sediment filter 118.

The collection tank 32 further includes a pump apparatus 122 disposed within the tank body 102 that includes a suitable pump (not labeled) configured to pump waste water within the collection tank 32 to a supply outlet pipe 126. The outlet pipe 126 is in communication with a piping structure (not shown) leading to one or more end uses (such as for use in cooling towers, irrigation, plumbing, etc.). The pump apparatus 122 may further include one of more filters or treatment devices configured to filter and/or treat the waste water before it reaches the outlet pipe 126. The pump apparatus 122 is a well known device that is available, along with the tank body 102, from Orenco Systems® Inc. of Southerland, Oreg. Therefore, a further detailed explanation of the pump apparatus 122 will not be hereinafter provided in detail.

The collection tank 32 further includes a float switch assembly 130 disposed within the tank body 102 that is configured to monitor the level of waste water within the tank body 102 and send appropriate control signals to the control system 36 depending on the waste water level detected. The float switch assembly 130 may include a float stem 134 extending downwardly into the tank body 102 and secured to any portion of the collection tank 32, such as the pump apparatus 122. A plurality of float switches are secured to the float stem 134 at predetermined spaced intervals along at least a portion of the length of the float stem 134. For instance, in the embodiment shown in FIG. 5, first, second, third, fourth, and fifth float switches 138, 140, 142, 144, and 146 are shown secured to the float stem 134, with the first float switch 138 being closest to a bottom interior portion of the tank body 102, and the fifth float switch being closest to a top interior portion of the tank body 102. Any suitable float switches configured to signal liquid level positions may be used. For instance, one embodiment of the present disclosure employs float switches from Orenco Systems® Inc. of Southerland, Oreg. are used. It should be appreciated that other types of sensors or switches may instead be used to detect predetermined water levels of the tank, or varying water levels within the tank.

The float switches are electrically coupled in a suitable manner to an electrical circuit 150 suitably designed to process the control signals generated from the float switches and send the appropriate command signals to the control system 36. The electrical circuit 150 communicates with the control system 36 via appropriate communication protocols known in the art. As will be described in further detail below, the signals generated by the float switches generate alarms, alerts, or certain operations in the water recovery systems 20, 60, or 84.

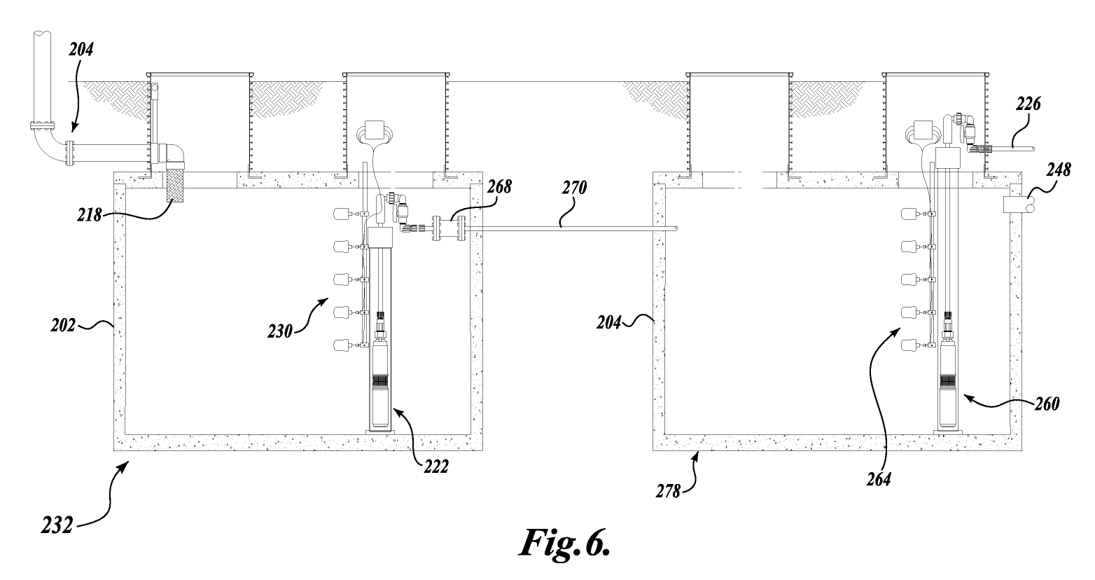

Referring now to FIG. 6, an alternate embodiment of a collection tank system for use with the water recovery systems 20, 60, and 84 will be hereinafter briefly described. As described above with respect to FIGS. 2 and 3, the water recovery systems may optionally include a second tank. The collection tank system depicted in FIG. 6 includes a first collection tank 232 in use with a second collection tank 278. The first and second collection tanks 232 and 278 are substantially similar to the collection tank 32 described above with reference to FIG. 5 except for the differences hereinafter provided. The first and second collection tanks 232 and 278 include a first and second substantially identical tank bodies 202 and 204 that are made from pre-cast concrete or any other suitable material. However, it should be appreciated that the first and second collection tanks 232 and 278 may instead be fiberglass tank bodies such as the tank body 102 described above with reference to FIG. 5. Likewise, it should be appreciated that the collection tank 32 described above with reference to FIG. 5 may instead have a pre-cast tank body as shown in FIG. 6.

The first collection tank 232 is in communication with an inlet pipe 204 substantially similar to the inlet pipe 104, wherein the inlet pipe 204 may be in communication with an intake manifold and source of potable water (not shown), as described above with reference to FIG. 5. A sediment filter 218 or other suitable filter may similarly be placed into communication with the inlet pipe 204. Moreover, the first collection tank 232 further includes a first pump apparatus 222 and a first float switch assembly 230 disposed within the tank body 202 that are substantially identical to the pump apparatus 122 and float switch assembly 130 described above with reference to FIG. 5. Similarly, the second collection tank 278 includes a substantially identical second pump apparatus 260 and second float switch assembly 264 disposed within the tank body 204.

The first collection tank 232 may be placed into communication with the second collection tank 278 through a piping structure 270 extending from the first pump apparatus 222 to the second tank body 204. As described above with reference to the water recover systems 60 and 84, a second collection tank may provide additional liquid storage if the holding storage of the first collection tank is not sufficient. In this case, the “overflow” of waste water in the first collection tank 232 may flow into the second collection tank 278, and the second collection tank may include an overflow drain 248. Furthermore, the second collection tank 278 may include an outlet pipe 226 in communication with the second pump apparatus 260 for distributing the waste water to one or more designated end uses.

An optional filtration and/or treatment system 268, similar in construction to the filtration and/or treatment system 40 described above, may be disposed between the first and second collection tanks 232 and 278. For instance, a bio-filter or UV filter may be placed into fluid communication with the piping structure 270. In this manner, the waste water may be further filtered before reaching the second collection tank 278 (and the end use). In the alternative, and as described above, the first collection tank 232 may include an outlet pipe (not shown) that selectively distributes water to a first end use requiring a first type of filtration and/or treatment (including no filtration or treatment). The second tank 78 may hold and distribute water to a second end use that requires a second type of filtration and/or treatment. For instance, the first collection tank 232 may distribute the waste water to a building gray water plumbing system (e.g., for flushing toilets), and the second collection tank 278 may distribute the waste water to an irrigation system.

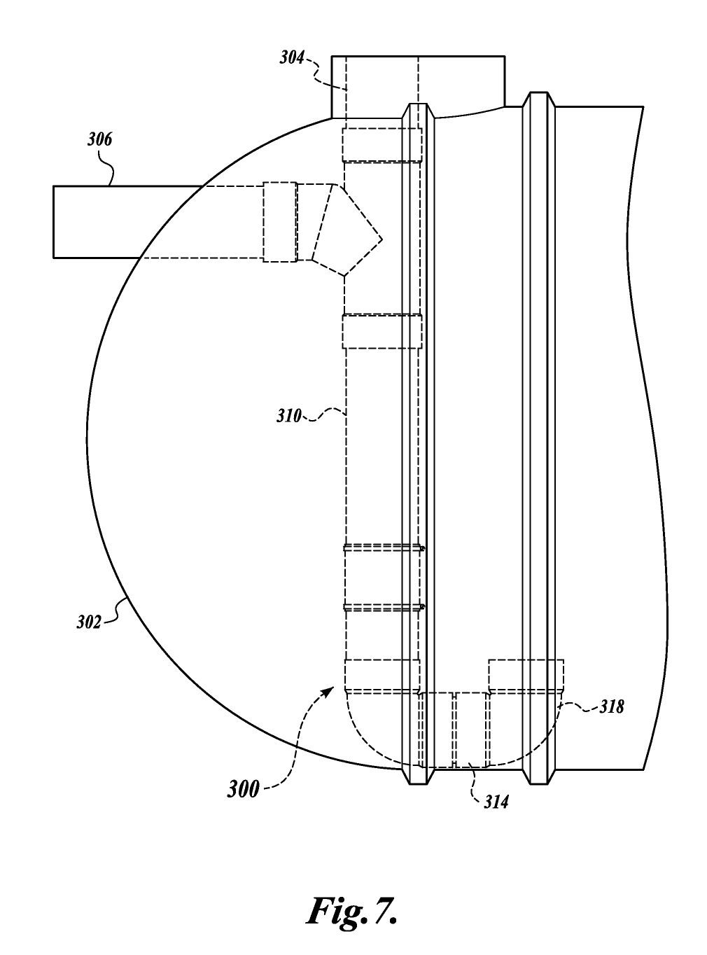

Turning now to FIG. 7, an inlet pipe assembly 300 for use in any of the above-described collection tanks will be hereinafter described. In general, the inlet pipe assembly 300 is designed to introduce the waste water (or the combination of waste water and potable water) into the collection tank in a manner that helps mix the newly introduced waste water with the stored waste water. More specifically, the inlet pipe assembly 300 includes a downwardly extending pipe portion 310 extending into a tank body 302 of any suitable design, such as that described above with respect to the collection tanks 32, 232, and 278 shown in FIGS. 5 and 6. The downwardly extending pipe portion 310 may be an extension of a first inlet pipe 304 carrying one or more sources of waste water or potable water (hereinafter referred to collectively as “waste water”). A second inlet pipe 306 may also be in fluid communication with the downwardly extending pipe portion 310. It should be appreciated that any number of inlet pipes may be in communication with the inlet pipe assembly 300.

The downwardly extending pipe portion 310 extends down into the tank to help introduce the waste water forcibly into the tank through the effects of gravity. A transition portion 314 extends horizontally from the downwardly extending pipe portion 310 toward an upwardly extending portion 318. In effect, the downwardly extending pipe portion 310, transition portion, and upwardly extending portion 318 define a substantially J-shaped inlet pipe assembly 300. The upwardly extending portion 318 terminates near the bottom of the tank body 302 to help introduce the waste water into the bottom of the tank body 302 in a manner that helps mix the waste water contents in the tank body 302.

As briefly described above, various components of the water recovery systems 20 and 84 are controlled by the control system 36. One embodiment of the control system 36 is illustrated as a block diagram in FIG. 8. Although not required, aspects of the present disclosure may be described in the general context of computer-executable instructions, such as program modules, being executed by a personal computer or computing device and stored, for example, on computer readable media, as will be described below. Generally, program modules include routines, programs, objects, components, data structures, etc., that perform particular tasks or implement particular abstract data types.

The control system 36 includes a computing device 402 having a processor 404, a memory 406, and I/O circuitry 408 suitably interconnected via one or more buses 412. The computing device 402 is connected to a source of power (which may include an internal battery), and may further be connected to a back-up power supply device to prevent failure of the control system 36 in the event of power outages. The system memory 406 may include read only memory (ROM), random access memory (RAM), and storage memory. The storage memory may include hard disk drives for reading from and writing to a hard disk, a magnetic disk drive for reading from or writing to a removable magnetic disk, and an optical disk drive for reading from or writing to a removable optical disk, such as a CD, DVD, or other optical media. The storage memory and their associated computer-readable media provide non-volatile storage of computer readable instructions, data structures, program modules, and other data for the computing device 402. Other types of computer readable media which can store data that is accessible by a computer, such as magnetic cassettes, flash memory cards, DVD-ROM, DVD-RAM, and the like, may also be used in the exemplary computing system.

The memory 406 stores an operating system 416 for controlling the operation of the computing device 402. In one embodiment of the disclosure, the operating system 416 provides a graphical operating environment, such as Microsoft Corporation's WINDOWS®, LINUX or Apple's Leopard graphical operating system in which activated applications, programs, or modules are represented as one or more graphical application windows with an interface visible to the user, such as a graphical user interface (GUI). The memory 406 also stores a number of program modules, such as an electronic flow metering valve program module 418, a filtration/treatment module 422, a float switch module 426, and program data 430, such as waste water flow data for each source of waste water, historical alarm data, sensor data, etc.

As shown in FIG. 8, the computing device 402 includes a network interface 434 comprising one or more components for communicating with other devices, e.g., control panels, cell phones, PDA's, laptop computer, network terminals, general purpose computing device, desktop computer, etc., over a wired and/or wireless network, such as a local area network (LAN) or a wide area network (WAN), such as the internet. As known to those skilled in the art and others, the computing devices illustrated in FIG. 6 may be configured to exchange files, commands, and other types of data over one or more networks. However, since protocols for network communication, such as TCP/IP, are well known to those skilled in the art, those protocols will not be described here. Additionally or alternatively, the computing device may be equipped with a modem (not shown) for connecting to the Internet through a point to point protocol (“PPP”) connection or a SLIP connection as known to those skilled in the art. For accessing the internet, the memory 406 may further include a web browser 438, such as Netscape's NAVIGATOR®, Microsoft's Internet Explorer, Mozilla's FireFox, etc.

The computing device 402 also includes an output device in the form of a graphical display 442 and several input devices 446, such as a keyboard, touch pad, microphone, a pointing device, or the like, for inputting data into the computing device 402, such as changing settings, manually controlling components, responding to requests from execution of the program modules 418, 422, and 426, etc. The display 442 and the user input devices 446 are suitably connected through appropriate interfaces, such as serial ports, parallel ports or a universal serial bus (USB) of the I/O circuitry. As would be generally understood, other peripherals may also be connected to the processor in a similar manner.

In one embodiment, the display 402 may include a touch sensitive layer on the screen that is configured to receive input from the user. In typical embodiments, the touch sensitive layer is configured to recognize a user's touches applied to the surface of the layer. For example, the position of the touches, the pressure of the touches, general direction of the touches, and the like are recognized by the touch sensitive layer. In one embodiment, the functionality of one or more inputs devices can be carried out by icons presented by the touch screen display and activated by an operator's finger, a stylus, etc. In another embodiment, the operator may interact with the virtual keyboard or keypad displayed on the display 402 via a finger, stylus, etc.

Input/Output circuitry 408 or other device level circuitry of the computing device 402 is connected in electrical communication with components of the water recovery system 20 (or the water recovery systems 60 or 84). In particular, signal and data generating devices, such as the electronic metering flow valves (42, 46, 52, etc.), the filtration and/or treatment systems 40, the collection tanks 32 and 78, cooling tower 88, etc., communicate with the computing device 402 via one or more protocols known in the art. The Input/Output circuitry 408 is further connected in electrical communication with any controllable switches, relays, etc., of the various components of the water recovery system 20, 60, or 84. In use, the Input/Output circuitry 408 or other device level circuitry is capable of receiving, processing, and transmitting appropriate signals between the processor 404 and these various components.

The program modules 418, 422, and 426, when executed by the computing device 402, presents a graphical user interface to the operator, which may open within a web browser or other graphical environment. The program modules 418, 422, and 426 are capable of graphically displaying information to and requesting and/or receiving data from the operator, analyzing data received from the components, and generating control signals to be transmitted to the components of the water recover systems 20, 60, or 84 through the I/O circuitry 408. The program modules 418, 422, and 426 further access stored data, such as historical flow data, end use waste water data, waste water quality data, etc.

As noted above, the electronic flow metering valve program module 418 includes instructions stored in the memory 406 that, when carried out by the processor 404, cause the control system 36 to perform certain functions. More specifically, the electronic flow metering valve program module 418 causes the control system 36 to receive fluid flow data, valve operational status data (i.e., open or closed), waste water quality data, etc., sent from the electronic flow metering valves and sensors described above. The electronic flow metering valve program module 418 also causes the control system 36 to process such data and generate alerts, alarms, reports or other representations of the data.

In one embodiment, the electronic flow metering valve program module 418 may cause the control system 36 to monitor the data received from electronic flow metering valves and sensors to determine if an alarm condition exists. For instance, if the fluid flow through a valve is low, high, etc., this may possibly indicate a leak or other mechanical or electrical component failure in the valve, meter, sensor, or other part of the water recovery system 20, 60, or 84. If it is determined that an alarm condition exists, the control system 36 may send an alert signal to the appropriated party. The alert signal could be a textual or graphical representation (on the display 442 of the computing device 402), an automatic page, a telephone or cellular phone call, an e-mail, or other means for notifying an operator, technician, etc., that is either local or remote from the system. It may also include an audible signal, such as a horn or buzzer, a visible signal, such as a flashing red light, etc. Further, the alert signal could shut down part or all of the water recovery system until operator or technician input is obtained. It may also cause the operator to manually check the system equipment.

In the alternative or in addition thereto, the electronic flow metering valve program module 418 may cause the control system 36 to create graphical representations (on the display 442 of the computing device 402) of the operational status of each electronic flow metering valve used in the water recovery system 20, 60, or 84. In that regard, the electronic flow metering valve program module 418 may also cause the control system 36 to provide a GUI that provides an operator with the ability to selectively monitor certain electronic flow metering valves, change the operational status of the electronic flow metering valves, etc.

The electronic flow metering valve program module 418 may additionally cause the control system 36 to create numerical reports to depict the real time or historical flow data of each electronic flow metering valve. For example, reports may be generated to indicate the number of cycles (open and closed) for each electronic flow metering valve, the fluid flow through the valves (to help detect leaks or other failures), etc. Further, reports may be generated to indicate the total amount of waste water recovered and used, as well as the monetary savings resulting from the recovery system. In addition, reports may be generated to determine the total amount of potable water used by the building, perhaps in comparison to use before implementation of the water recovery system 20, 60, or 84. In that regard, additional electronic flow metering valves may be placed on the main line of the facility or building to measure the total potable water use for the building. Such measured data may be useful in conducting an audit of water utility reports or bills provided by third party water suppliers.

It should be appreciated that the electronic flow metering valve program module 418 may cause the control system 36 to create any suitable GUI, data report, alerts, alarms, etc., for monitoring and/or controlling the electronic flow metering valves of the water recover systems 20, 60, and 84.

Turning now to the filtration/treatment module 422, the filtration/treatment module 422 includes instructions stored in the memory 406 that, when carried out by the processor 404, cause the control system 36 to perform certain functions. As discussed above with regard to the water recovery systems 20, 60, and 84, the sources of waste water (including condensate, rainwater, building drainage water, and blow-down water) may optional pass through a filtration and/or treatment system (configured similar to the filtration and/or treatment system 40) before reaching the collection tank 32 or end use 44. Any suitable filtration or treatment methods may be used depending on the quality of the waste water (for instance, the concentration of particulate matter or total dissolved solids (“TDS”)) and the end use of the waste water.

In one embodiment, the filtration/treatment module 422 can receive waste water quality data sent from the electronic metering sensors described above or other sensors or measurements devices in the system. In response to this data, the filtration/treatment module 422 can cause the control system 36 to automatically employ certain types of filtration and/or treatment devices and systems to appropriately treat and/or filter the waste water for the intended end use. In another embodiment, or in addition thereto, the filtration/treatment module 422 can cause the control system 36 to create graphical representations (on the display 442 of the computing device 402) to indicate which (if any) filtration and/or treatment devices and systems are being used. In that regard, the filtration/treatment module 422 may also cause the control system 36 to provide a GUI that provides an operator with the ability to selectively monitor certain filtration and/or treatment devices and systems, change the operational status of the filtration and/or treatment devices and systems, etc. It will be appreciated that in some embodiments, the filtration and/or treatment is not controlled by the control system 36, and therefore, filters and/or treats any water flowing therethrough.

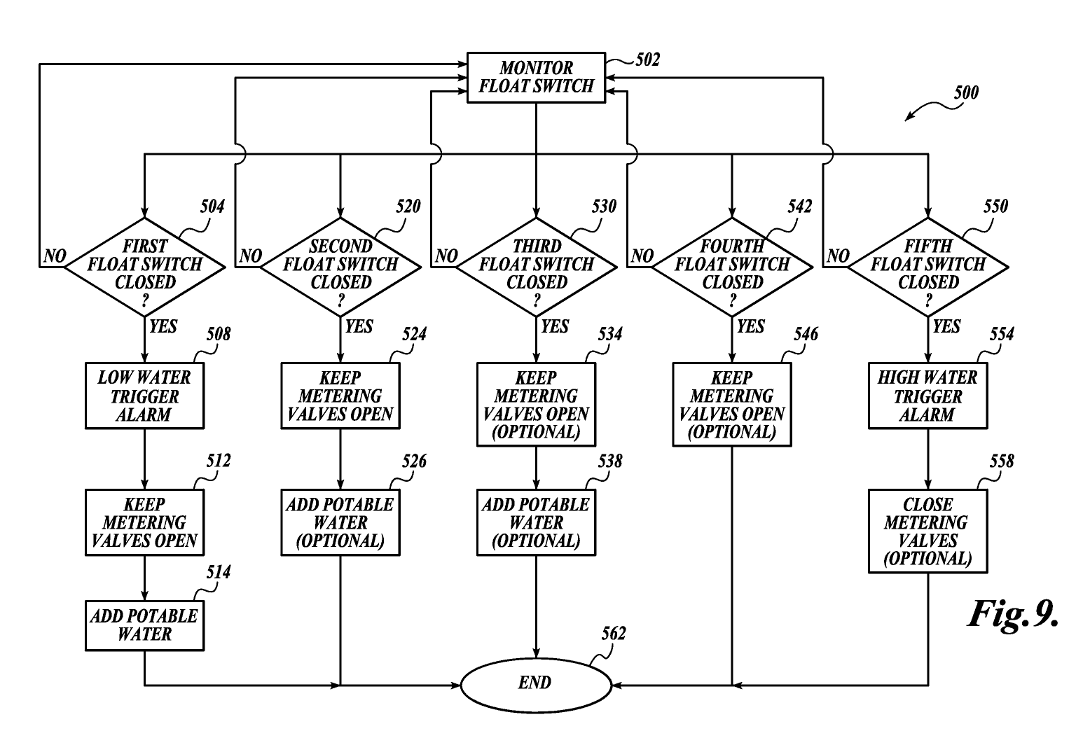

Turning now to FIG. 9, there is shown a flow diagram of one exemplary float switch module routine 500 executed by the float switch module 426. As briefly described above, the collection tank may include a float switch assembly, such as float switch assembly 130, having a plurality of float switches positioned at predetermined spaced intervals along a float stem within the tank. In the above-described float switch assembly 130, the float switches can send a signal to the control system 36 (through an electrical circuit 150) to indicate the level of waste water in the tank. Each float signal, if normally in an open position, may be closed upon the water level reaching the threshold level of the corresponding float switch within the tank. The float switch module routine 500 monitors each float switch within the float switch assembly and causes the control system 36 to perform certain functions in response to signals received from the float switches.

One example of operations carried out by the control system 36 in response to the float switch module routine 500 will now be described with reference to the float switch assembly 130 shown in FIG. 5. Routine 500 begins at block 502, where the control system 36 is monitoring the float switches 138, 140, 142, 144, and 146 in the float switch assembly 130 (See FIG. 5). The first float switch 138, which is located near the bottom of the tank body 102, closes if the waste water level in the tank is at or below the threshold level of the first switch 138 (thereby closing the switch). Thus, the routine 500, at decision block 504, determines whether the first float switch 138 is closed.

If the answer is “yes,” the routine 500 proceeds to block 508, where the control system 36 may trigger an alarm or otherwise send an alert signal to the appropriated party to indicate that the waste water level is low. The alert signal could be a textual or graphical representation (on the display 442 of the computing device 402), an automatic page, a telephone or cellular phone call, an e-mail, or other means for notifying an operator, technician, etc., that is either local or remote from the water recovery system 20. It may also include an audible signal, such as a horn or buzzer, a visible signal, such as a flashing red light, etc. Further, the alert signal could shut down part or all of the water recovery system 20 until operator or technician input is obtained. It may also cause the operator to manually check the equipment.

The routine 500 may further proceed to block 512, where the control system 36 may automatically or through operator commands send the appropriate control signals to the electronic flow metering valves of the system to keep the waste water valves open. In this manner, waste water from the various sources continues to flow into the collection tank to help raise the waste water level in the collection tank. The routine 500 may also proceed to block 514, where the control system 36 may automatically or through operator commands send the appropriate control signals to the electronic flow metering valve of the potable water source to open the valve. In this manner, potable water will flow into the collection tank to help raise the waste water level in the collection tank. Once the waste water level in the tank rises above the predetermined threshold of the first float switch 138, the first float switch will open, and the routine 500 will proceed to block 562.

The routine 500 begins again at block 502 where the control system 36 is monitoring the float switches 138, 140, 142, 144, and 146 in the float switch assembly 130. The routine 500, at decision block 520, may then determine whether the second float switch 140 is closed. If the answer is “yes,” the routine 500 proceeds to block 524, where the control system 36 sends the appropriate control signals to the electronic flow metering valves to keep the waste water valves open to raise the waste water level in the tank. The routine 500 may optionally proceed to block 526, where the control system 36 may send the appropriate control signals to the electronic flow metering valve of the potable water source to open the valve to further raise the level of waste water in the tank. Once the waste water level in the tank rises above the predetermined threshold of the second float switch 140, the second float switch will open, and the routine 500 will proceed to block 562.

The routine 500, at decision block 530, may then determine whether the third float switch 142 is closed. If the answer is “yes,” the routine 500 may optionally proceed to block 534, where the control system 36 sends the appropriate control signals to the electronic flow metering valves to keep the waste water valves open to raise the waste water level in the tank. The routine 500 may also optionally proceed to block 538, where the control system 36 may send the appropriate control signals to the electronic flow metering valve of the potable water source to open the valve to further raise the level of waste water in the tank. Once the waste water level in the tank rises above the predetermined threshold of the third float switch 142, the third float switch will open, and the routine 500 will proceed to block 562.

The routine 500, at decision block 542, may then determine whether the fourth float switch 144 is closed. If the answer is “yes,” the routine 500 may optionally proceed to block 546, where the control system 36 sends the appropriate control signals to the electronic flow metering valves to keep the waste water valves open to raise the waste water level in the tank. Once the waste water level in the tank rises above the predetermined threshold of the fourth float switch 144, the fourth float switch will open, and the routine 500 will proceed to block 562.

Finally, the routine 500, at decision block 550, may then determine whether the fifth float switch 146 is closed. If the answer is “yes,” the routine 500 proceeds to block 554, where the control system 36 may trigger an alarm or otherwise send an alert signal to the appropriated party, as described above with respect to block 508, to indicate that the waste water level is high.

The routine 500 may optionally proceed to block 558, where the control system 36 may automatically or through operator commands send the appropriate control signals to the electronic flow metering valves of the system to close one or more of the waste water valves. In this manner, the waste water flow from the various sources will be restricted or stopped, thereby helping to reduce or otherwise maintain the waste water level in the collection tank.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

1. A water recovery system, comprising:
one or more condensate collectors each associated with at least one condensate generator for collecting condensate therefrom;
a cooling tower connected in liquid communication with the one or more condensate collectors, wherein the cooling tower discharges blow down water;
a cooling tower collector for collecting the blow down water from the cooling tower; and
a liquid storage tank connected in liquid communication with the cooling tower collector for holding at least the blow down water collected from the condensate generator; wherein the liquid storage tank includes an outlet for supplying the collected blow down water to a recycled use.

2. The water recovery system of claim 1, wherein the liquid storage tank is selectively connectable to a source of potable water for diluting the collected blow down water in the liquid storage tank.

3. The water recovery system of claim 1, further comprising a controllable valve that selectively connects the liquid storage tank with a source of water.

4. The water recovery system of claim 3, further comprising a controller that is programmed to control the controllable valve based on a characteristic of the blow down water collected by the blow down collector.

5. The water recovery system of claim 3, wherein the cooling tower outputs data indicative of water quality, and wherein the source of water is connected to the liquid storage tank when the water quality is below a preselected level.

6. The water recovery system of claim 1, further comprising a rainwater collector and a sprinkler system collector connected in fluid communication with the liquid storage tank.

7. The water recovery system of claim 2, further comprising:
first and second valves for selectively controlling the delivery of the condensate and the potable water, respectively; and
first and second flow meters for measuring the flow rate of the condensate and the potable water flowing to the liquid storage tank

8. The water recovery system of claim 7, further comprising:
a controller programmed to receive signals from the first and second valves and the first and second flow meters, process the signals to obtain data, and assemble the data; and
a display that displays the assembled data in numerical or graphic form.

9. A method of reusing waste water, comprising:
collecting condensate from one or more condensate generators;
storing the collected condensate in a liquid storage tank as waste water; and
supplying the waste water to at least one recycled use.

10. The method of claim 9, further comprising:
collecting water from one or more water sources discrete from the condensate generators; and
storing the collected water in the liquid storage tank with the condensate as waste water.

11. The method of claim 10, further comprising:
filtering the condensate and/or waste water.

12. The method of claim 10, further comprising:
selectively delivering the collected condensate to the liquid storage tank; and
selectively delivering the collected water to the liquid storage tank.

13. The method of claim 10, further comprising:
measuring the amount of condensate and water delivered to the liquid storage tank.

14. The method of claim 13, further comprising:
collecting the measurement data;
storing the data; and
displaying the data in numerical or graphical form.

15. The method of claim 9, wherein the at least one recycled use includes two or more of an irrigation system, a fountain, gray water plumbing, and a cooling tower.

16. The method of claim 15, further comprising:
selectively supplying the waste water to one of the recycled uses based on an operational condition.

17. The method of claim 16, wherein the operational condition is selected from a group consisting of water quality, time of day, day of week, and quantity of waste water in the liquid storage tank.

18. The method of claim 12, further comprising:
measuring the waste water level in the liquid storage tank; and
supplying water from one of the water sources depending on the water level in the liquid storage tank.

19. A water recovery system, comprising:
a plurality of condensate collectors each associated with at least one condensate generator for collecting condensate therefrom;
a liquid storage tank connected in liquid communication with the plurality of condensate collectors for holding at least the condensate collected from the condensate generators, wherein the liquid storage tank includes an outlet for supplying at least the collected condensate to a recycled use; and
one or more conduits connecting the plurality of condensate collectors in liquid communication with the liquid storage tank.

20. The water recovery system of claim 19, wherein the recycled use is selected from a group consisting of an irrigation system, a fountain, gray water plumbing, and a cooling tower.

21-46. (canceled)
